(19) United States
(12) Patent Application Publication
(10) Pub. No.: US 2014/0110905 A1
(43) Pub. Date: Apr. 24, 2014

(54) SEALING STRUCTURE FOR COUPLING PORTION OF FUEL PIPE AND FUEL RAIL FOR VEHICLE

(71) Applicant: HYUNDAI MOTOR COMPANY, Seoul (KR)

(72) Inventor: Bong Kyo Seo, Suwon-si (KR)

(73) Assignee: Hyundai Motor Company, Seoul (KR)

(21) Appl. No.: 13/658,531

(22) Filed: Oct. 23, 2012

(51) Int. Cl. F02F 11/00

(52) U.S. Cl. 277/591

(57) ABSTRACT

A sealing structure of coupling a fuel pipe and a fuel rail for a vehicle, may include the fuel pipe having a fuel channel formed therein and a sealing member at an outer surface thereof, a connection pipe of the fuel rail having an insertion portion into which the fuel pipe may be inserted, wherein a first sealing surface may be formed at a lower portion in an inner side of the insertion portion and sealed with the sealing member of the fuel pipe, and a leakage preventing portion provided between the sealing member of the fuel pipe and the inner side of the insertion portion positioned over the first sealing surface to prevent fuel from being leaked to the outside of the insertion portion.

### BACKGROUND OF THE INVENTION

1. Field of the Invention

The present invention relates to a sealing structure for a coupling portion of a fuel pipe and a fuel rail for a vehicle, and more particularly, to a sealing structure for a coupling portion of a fuel pipe and a fuel rail for a vehicle capable of preventing fuel from being leaked.

2. Description of Related Art

In a vehicle industry, as a countermeasure to green growth and human friendly trends, an effort to develop a gasoline direct injection (GDI) engine for CO2 restriction, high gas mileage, and high output has recently been conducted.

In the GDI engine, a fuel pipe and a fuel rail among components of a high pressure fuel system are connected to each other as shown in FIG. 1. That is, a fuel pipe 110 according to the related art is coupled to a connection pipe 125 of a fuel rail 120 via a coupling member 140.

Here, a sealing structure of a coupling portion A of the fuel pipe 110 and the fuel rail 120 is configured to include the fuel pipe 110 having a fuel channel 110a formed therein, the connection pipe 125 of the fuel rail 120 provided with an insertion portion 123 into which the fuel pipe 110 is inserted, and the coupling member 140 coupled to outer peripheral surfaces of the fuel pipe 110 and the connection pipe 125, as shown in FIG. 2.

Here, an upper portion of an inner side of the insertion portion 123 of the connection pipe 125 is provided with a sealing surface S sealed with the fuel pipe 110.

However, in the sealing structure of the coupling portion A of the fuel pipe 110 and the fuel rail 120 according to the related art, in the case in which the pipe 110 is assembled to the insertion portion 123 of the connection pipe 125 in a state in which it is biased toward one side as shown in FIG. 3 due to a narrow work space, a work deviation between workers, or the like, fuel may be leaked through a space formed at the other side.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a sealing structure for a coupling portion of a fuel pipe and a fuel rail for a vehicle capable of preventing fuel from being leaked.

In an aspect of the present invention, a sealing structure of coupling a fuel pipe and a fuel rail for a vehicle, may include the fuel pipe having a fuel channel formed therein and a sealing member at an outer surface thereof, a connection pipe of the fuel rail having an insertion portion into which the fuel pipe is inserted, wherein a first sealing surface is formed at a lower portion in an inner side of the insertion portion and sealed with the sealing member of the fuel pipe, and a leakage preventing portion provided between the sealing member of the fuel pipe and the inner side of the insertion portion positioned over the first sealing surface to prevent fuel from being leaked to the outside of the insertion portion.

The leakage preventing portion may include an O-ring fitted onto a receiving groove formed in an outer peripheral surface of the sealing member and made of an elastic material.

The leakage preventing portion further may include a stopper positioned over the O-ring in the receiving groove of the fuel pipe in a longitudinal direction of the fuel pipe to prevent the O-ring from being moved.

The sealing structure may further may include a coupling member coupled to outer peripheral surfaces of the sealing member and the connection pipe, wherein an inner side of the coupling member positioned over the leakage preventing portion is provided with a second sealing surface sealed with the sealing member of the fuel pipe to prevent the fuel from being leaked to the outside of the coupling member.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing a coupling portion of a fuel pipe and a fuel rail for a vehicle according to the related art.

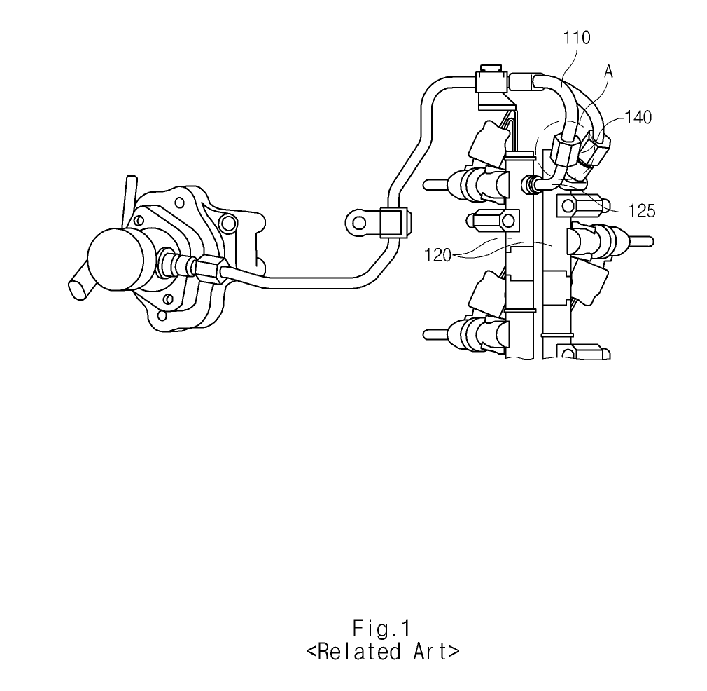

FIG. 2 is a cross-sectional view of the portion A of FIG. 1.

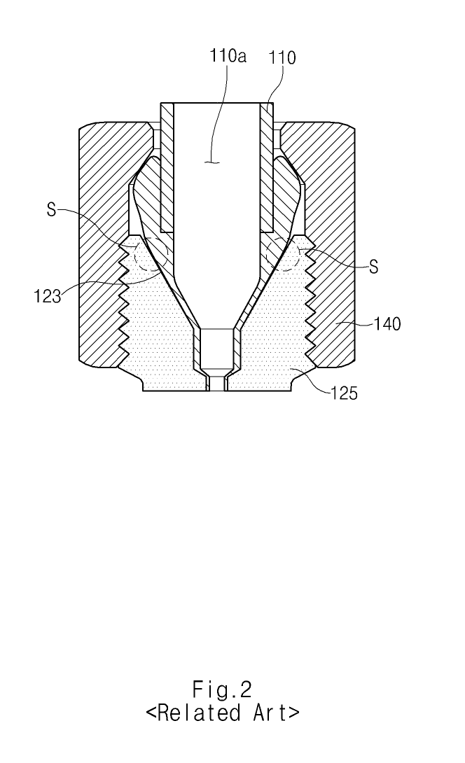

FIG. 3 is a cross-sectional view showing an example in which a fuel pipe of FIG. 2 is assembled to a connection pipe in a state in which it is biased.

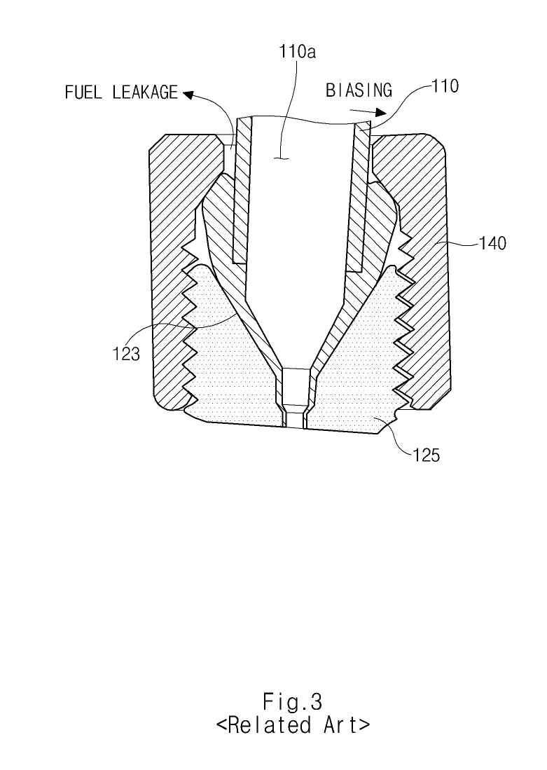

FIG. 4 is a cross-sectional view a sealing structure for a coupling portion of a fuel pipe and a fuel rail for a vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described in detail with reference to the accompanying drawings.

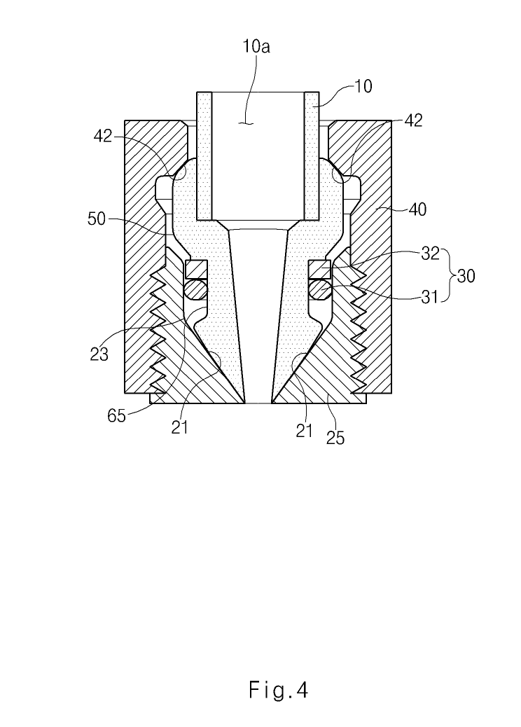

Here, a sealing structure of a coupling portion of a fuel pipe and a fuel rail for a vehicle according to an exemplary embodiment of the present invention is configured to include a fuel pipe 10 having a fuel channel 10a formed therein, a connection pipe 25 of a fuel rail provided with an insertion portion 23 into which the fuel pipe 10 is inserted, and a coupling member 40 coupled to outer peripheral surfaces of the fuel pipe 10 and the connection pipe 25, as shown in FIG. 4.

In an exemplary embodiment of the present invention, the fuel pipe 10 is formed of a sealing member 50 at an end thereof and coupled to the coupling member 40 and the connecting pipe 25.

The sealing member 50 includes a receiving groove 65 formed an exterior circumference thereof.

The connection pipe 25 has one end connected to the fuel rail and the other end connected to the fuel pipe 10.

Here, a lower portion of an inner side of the connection pipe 25 is provided with a first sealing surface 21 sealed with the sealing member 50 of the fuel pipe 10.

Meanwhile, a leakage preventing portion 30 preventing fuel from being leaked to the outside of the insertion portion 23 is provided between an inner side of the insertion portion 23 positioned over the first sealing surface 21 and the outer peripheral surface of the fuel pipe 10.

The leakage preventing portion 30 is positioned over the first sealing surface 21, such that it serves to prevent the fuel from being leaked to the outside of the insertion portion 23 even though the fuel pipe 10 is assembled to the insertion portion 23 in a state in which it is biased toward one side.

Here, the leakage preventing portion 30 includes an O-ring 31 fitted onto the receiving groove 65 formed in the outer peripheral surface of the fuel pipe 10 and made of a rubber material and a stopper 32 positioned over the O-ring 31 and fitted onto the outer peripheral surface of the fuel pipe 10.

The stopper 32 is positioned over the O-ring 31 to serve to prevent the O-ring 31 from being moved from the fuel pipe 10.

The coupling member 40 is coupled to the outer peripheral surfaces of the fuel pipe 10 and the connection pipe 25. Particularly, the coupling member 40 is screwed to the connection pipe 25.

Here, an inner side of the coupling member 40 is provided with a second sealing surface 42 sealed with the fuel pipe 10 to prevent the fuel from being leaked to the outside of the coupling member 40.

The second sealing surface 42 is positioned over the leakage preventing portion 30, such that it serves to again prevent the fuel from being leaked to the outside of the coupling member 40 even though the fuel is leaked to the outside of the insertion portion 23 of the connection pipe 10 due to biasing of the first sealing surface 21, an assembling defect of the leakage preventing portion 30, or the like.

As set forth above, with the sealing structure of a coupling portion of a fuel pipe and a fuel rail for a vehicle according to the exemplary embodiment of the present invention, even though the fuel pipe 10 is assembled to the insertion portion 23 of the connection pipe 25 in a state in which it is biased, such that sealing is not appropriately made on the first sealing surface 21, the leakage of the fuel may be prevented by the leakage preventing portion 30.

In addition, with the sealing structure of a coupling portion of a fuel pipe and a fuel rail for a vehicle according to the exemplary embodiment of the present invention, the second sealing surface 42 sealed with the fuel pipe 10 is formed at the inner side of the coupling member 40 to again block the fuel leaked from the leakage preventing portion 30 due to the assembling defect, or the like, thereby making it possible to fundamentally prevent the leakage of the fuel.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sealing structure of coupling a fuel pipe and a fuel rail for a vehicle, comprising:
the fuel pipe having a fuel channel formed therein and a sealing member at an outer surface thereof;
a connection pipe of the fuel rail having an insertion portion into which the fuel pipe is inserted, wherein a first sealing surface is formed at a lower portion in an inner side of the insertion portion and sealed with the sealing member of the fuel pipe; and
a leakage preventing portion provided between the sealing member of the fuel pipe and the inner side of the insertion portion positioned over the first sealing surface to prevent fuel from being leaked to the outside of the insertion portion.

2. The sealing structure according to claim 1, wherein the leakage preventing portion includes an O-ring fitted onto a receiving groove formed in an outer peripheral surface of the sealing member and made of an elastic material.

3. The sealing structure according to claim 2, wherein the leakage preventing portion further includes a stopper positioned over the O-ring in the receiving groove of the fuel pipe in a longitudinal direction of the fuel pipe to prevent the O-ring from being moved.

4. The sealing structure according to claim 1, further including a coupling member coupled to outer peripheral surfaces of the sealing member and the connection pipe,
wherein an inner side of the coupling member positioned over the leakage preventing portion is provided with a second sealing surface sealed with the sealing member of the fuel pipe to prevent the fuel from being leaked to the outside of the coupling member.
